(19) United States
(12) Patent Application Publication
(10) Pub. No.: US 2024/0418923 A1
(43) Pub. Date: Dec. 19, 2024

(54) METHOD FOR PRODUCING A HOLOGRAM FOR A RETROREFLECTOR AND METHOD FOR PRODUCING A RETROREFLECTOR FOR A VEHICLE

(71) Applicant: Hella GmbH & Co. KGaA, Lippstadt (DE)

(72) Inventors: Lukas Hiller, Lippstadt (DE); Daniela Karthaus, Büren (DE); Mathias Niedling, Lippstadt (DE); Christian Schmidt, Paderborn (DE)

(21) Appl. No.: 18/744,616

(22) Filed: Jun. 15, 2024

(30) Foreign Application Priority Data
Jun. 16, 2023 (DE) 102023115853.8

(51) Int. Cl. G02B 5/32; G03H 1/04; G03H 1/24

(52) U.S. Cl. CPC G02B 5/32; G03H 1/041; G03H 1/24; G03H 2222/54

(57) ABSTRACT

A method is provided for producing a hologram for a retroreflector. A retroreflector is provided containing numerous facets, each of which reflects light. A photosensitive recording material is applied to the retroreflector. A laser beam is generated, and numerous facets of the retroreflector are successively lit with the laser beam through the recording material, such that the laser beam is reflected by each of the facets and then passes back though the recording material. The laser beam that moves through the recording material toward the facet is a reference beam, and the laser beam reflected back by the facet forms an object beam, such that a segment of the hologram is generated in a part of the photosensitive recording material in front of each of the facets by superimposing the laser beam moving toward the facet with the reflected laser beam.

### CROSS REFERENCE

This application claims priority to German Application No. 10 2023 115853.8, filed Jun. 16, 2023, the entirety which is hereby incorporated by reference.

### FIELD OF THE INVENTION

The present invention relates to a method for producing a hologram for a retroreflector, a hologram produced with this method, as well as a method for producing a retroreflector for a vehicle and a retroreflector for a vehicle produced with this method.

### BACKGROUND OF THE INVENTION

There are retroreflectors for vehicles. They increase the visibility of vehicles and contribute to traffic safety. The current implementations do not allow for much design variation. In particular, the appearance of the faceted surfaces of typical retroreflectors can only be modified to a limited extent.

A method for producing a retroreflector is disclosed in DE 30 12 500 A1, in which reflecting surfaces of the individual facets are formed in part by superimposing grids, each of which forms a three dimensional hologram. In particular, two holographic grids that are at a right angle to one another are recorded in a three dimensional hologram in the method described in DE 30 12 500 A1. Light striking it is first reflected on the surfaces of the first grid. This light is then reflected at the second grid. Because the grids are at a right angle to one another, and are at 45° to the substrate, a retroreflection of 180° can be obtained. The grids used in this method are difficult to record, because two light beams must be superimposed for each grid. The reference beam meets the hologram moving in the direction of the substrate. The object beam must enter the medium at a right angle to the substrate. This is impossible with thin recording media, because the Fresnel reflection at 90° is nearly 100%. Therefore, only very thick recording media can be used with this method, which light can enter from the sides. The angular selectivity of the three dimensional holograms that are used is also problematic. Beams are only reflected by the retroreflector that strike it at nearly 90°. Non-paraxial beams are not reflected, and pass through the hologram.

It is therefore impossible to produce retroreflectors for vehicles with the method described in DE 30 12 500 A1, because retroreflectors for vehicles and bicycles must be able to reflect light back over a large range of angles due to legal stipulations.

### BRIEF SUMMARY OF THE INVENTION

The fundamental problem addressed by the present invention is to create a method of the type described above for producing a hologram with which light can be reflected in a retroreflector for vehicles, substantially toward where the light striking the retroreflector came from. Furthermore, a hologram is to be created with this method, a method for producing a retroreflector for a vehicle of the above type is to be obtained, and a retroreflector for a vehicle produced with this method is to be created.

In an example embodiment, the method for producing a hologram comprises the following steps: providing a retroreflector that has numerous facets, each of which reflects light; applying a photosensitive recording material to the retroreflector; generating a laser beam; successively lighting the numerous facets of the retroreflector with the laser beam through the recording material such that the laser beam is reflected by each facet and thus passes back through the recording material, in which each laser beam passing through the recording material toward the facets forms a reference beam, and the laser beams reflected by the facets form object beams, such that a segment of a hologram is generated in the part of the photosensitive recording material in front of each of the facets by superimposing the laser beam moving toward the facets with the reflected laser beam.

When light strikes a hologram produced with this method, this light corresponds to a reference beam that the object beam reconstructs. The object beam moves away from the hologram in the direction substantially opposite that of the reference beam, such that the hologram functions like a retroreflector that reflects light back in the direction from which it came. The recording material in which the hologram is recorded is normally unstructured, such the retroreflector obtained with the hologram does not exhibit any visible structures such as facets. This improves the appearance of the retroreflector obtained with the hologram.

Each of the facets of the retroreflector can be designed to reflect light striking it from one direction in another direction that is opposite thereto. The segments of the hologram in front of the respective facets can therefore reflect light striking them like the respective facets.

The retroreflector can be transparent for visible light. This ensures that the recording material containing the hologram obtained with the method remains transparent when it is not lit. This results in significant design advantages, because the hologram can be applied to transparent surfaces on a vehicle, and because other lighting functions can be placed behind the retroreflector hologram.

The retroreflector can have an unstructured, smooth surface, and the photosensitive recording material can be applied to the smooth surface. It is easier to apply the recording material to a smooth surface. By way of example, the photosensitive recording material can be laminated to the retroreflector, in particular the smooth surface of the retroreflector.

The photosensitive recording material can be a film, in particular a photopolymer film. These films can be easily applied to the smooth surfaces of the retroreflector used in the production process. These films can also be easily placed on different substrates or parts of vehicles for use as retroreflectors.

The laser beam can converge when passing through the recording material toward the facets, such that the laser beam substantially lights the entire facet. This ensures that the retroreflector obtained with the hologram can reflect light back over a large range of angles.

The laser beam can be colored, e.g. with a wavelength in the red spectrum, or the laser beam can be composed of numerous beams of different wavelengths, such that the appearance of white light is obtained.

By producing the hologram with colored, in particular red, laser beams, only a red object beam is reconstructed when white light strikes a retroreflector that contains the hologram. A hologram recorded with red laser beams can therefore produce a red retroreflector, such as that used for taillights.

By producing the hologram with white laser beams, a white object beam is reconstructed with the retroreflector obtained with the hologram. A hologram obtained with white laser beams can therefore produce a white retroreflector. The white light striking the retroreflector containing the hologram can be the light from a headlamp on another vehicle.

The photosensitive recording material can be removed from the retroreflector after projecting the hologram thereon. The hologram removed in this manner from the retroreflector can then be used as a master for producing replicas.

The hologram may be produced with a method in which the hologram is intended for use with a light source that generates white light in particular.

The method for producing a retroreflector comprises the following steps: producing a hologram, in particular a replica hologram, with a method according to the invention for producing a hologram; applying this hologram to a substrate.

The hologram can be applied to the substrate by laminating the film containing the hologram to the substrate.

The substrate may be transparent, at least for part of the visible light spectrum, and form a component of a lighting device, e.g. a cover panel for a lighting device. The hologram then remains invisible when it is not lit. It first becomes visible when it is lit by the light reflected back through it.

The substrate does not have to be transparent, in which case it forms a coated component. The hologram in the film can also be applied to arbitrary parts of the vehicle body. Back lighting of darkly coated parts is also referred to as a black panel effect.

The retroreflector may be produced with a method according to the invention.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 schematically illustrates a method according to the invention for producing a hologram.

FIG. 2 shows a section view of the retroreflector used for the method in FIG. 1.

### DETAILED DESCRIPTION OF THE DRAWINGS

Identical and functionally identical parts have the same reference symbols in the drawings.

A retroreflector 1 that can be used for the method for producing a hologram is shown schematically in FIG. 2. The retroreflector 1 has numerous facets 2, formed by way of example by three reflective surfaces 3 that are perpendicular to one another. The reflective surfaces 3 in a facet 2 can be placed in relation to one another in the manner of the inner surfaces of a hollow cube meeting at a corner.

Light 4 striking the surfaces 3 of the facets 2 of the retroreflector 1 from a first direction is reflected to form reflected light 5 moving in a second direction, substantially opposite the first (see the examples in FIG. 2).

The retroreflector 1 can have other designs. In particular, the retroreflector 1 can be formed by a transparent substrate with a smooth surface, not shown, on the upper surface of the retroreflector 1 in FIG. 2, which is not structured. The light 4 striking it can pass through the smooth surface into the substrate. With this embodiment, the surfaces 3 of the individual facets 2, which are perpendicular to one another, can be formed inside the substrate, in which case the reflection takes the form of total internal reflection, or can be obtained through a reflective coating at the back of the substrate.

A photosensitive recording material 6 is applied to the preferably transparent retroreflector 1 in order to execute the method for producing a hologram. In particular, the recording material 6 can be applied to the smooth, unstructured surface on the front of the retroreflector 1 (not shown). The recording material 6, or film, can be glued or laminated to the retroreflector 1.

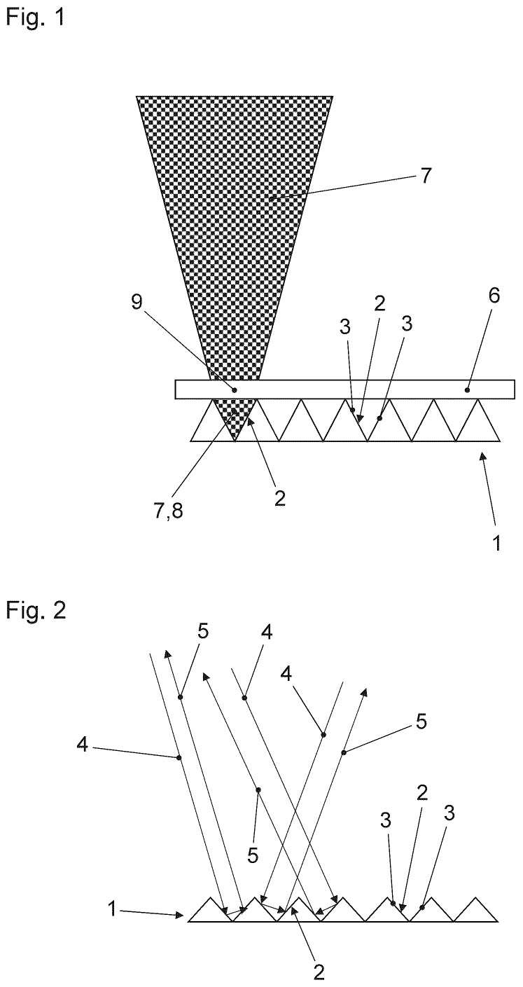

A laser beam 7 is shown in FIG. 1, which passes through the recording material 6 and strikes a facet 2 of the retroreflector 1, or its reflective surface 3. The laser beam 7 is convergent in this exemplary embodiment. The laser beam 7 substantially lights the entire facet 2.

The laser beam 7 can be colored, e.g. having a wavelength in the red spectrum. The laser beam 7 can also comprise numerous laser beams of different wavelengths, which are combined to obtain the appearance of white light.

The laser beam 7 is reflected by the facet 2, forming a reflected laser beam 8 that passes back through the recording material 6. The laser beam 7 passing through the recording material 6 toward the facet 2 forms the reference beam, and the laser beam 2 reflected back by the facet 2 forms the object beam. A segment of the hologram is generated by superimposing the laser beam 7 moving toward the facet 2 with the laser beam 8 that has been reflected back into the part of the photosensitive recording material 6 in front of the facet 2.

After generating or recording a segment of the hologram in the section 9 of the recording material 6 in front of the facet 2 lit by the laser beam 7 in FIG. 1, the laser beam 7 is moved to strike a subsequent facet 2. A segment of the hologram is also recorded in a section of the recording material 6 in front of this facet 2. All of the facets 2 of the retroreflector 1 are lit by the laser beam 7 in this manner, until a corresponding segment of the hologram has been recorded in each section of the recording material 6 in front of a facet 2.

After the hologram has been recorded, the recording material 6 is removed from the retroreflector 1. When light strikes a hologram produced with this method, the light forms a reference beam that is reconstructed by the object beam. The object beam moves away from the hologram in the direction substantially opposite that of the reference beam, such that the hologram functions like a retroreflector that reflects light back toward where it came from.

The hologram recorded in the recording material can be used in the conventional manner as a master hologram for making replica holograms.

The hologram recorded in the recording material 6, or a replica hologram produced therewith, can be applied to a substrate in a later step, not shown, in particular by laminating it thereto. The substrate with the hologram applied to it can be used as a retroreflector.

The substrate can be transparent, at least for part of the visible light spectrum, forming a component of a lighting device, e.g. a cover panel. Alternatively, the substrate can be opaque, in which case it is coated with an opaque material.

### LIST OF REFERENCE SYMBOLS

1 retroreflector
2 facet of the retroreflector
3 reflective surface of the facet
4 light striking a facet
5 light reflected by a facet
6 recording material
7 laser beam
8 reflected laser beam
9 part of the recording material in front of a facet

1. A method for producing a hologram for a retroreflector, the method comprising the following steps:
providing a retroreflector containing numerous facets, each of said facets reflecting light;
applying a photosensitive recording material to the retroreflector;
generating a laser beam;
successively lighting a plurality of the facets of the retroreflector with the laser beam through the recording material, such that the laser beam is reflected by each of the facets and then passes back though the recording material;
wherein the laser beam moving through the recording material toward the facet is a reference beam, and the laser beam reflected back by the facet forms an object beam, such that a segment of the hologram is generated in a part of the photosensitive recording material in front of each of the facets by superimposing the laser beam moving toward the facet with the reflected laser beam.

2. The method according to claim 1, wherein the facets of the retroreflector reflect the light striking them from a first direction back, in a second, opposite direction.

3. The method according to either claim 1, wherein the retroreflector is transparent for visible light.

4. The method according to claim 1, wherein the retroreflector has an unstructured, smooth upper surface, wherein the photosensitive recording material is applied to this smooth upper surface.

5. The method according to claim 1, wherein the photosensitive recording material is laminated to the retroreflector.

6. The method according to claim 1, wherein the photosensitive recording material is a film.

7. The method according to claim 1, wherein the laser beam converges when passing through the recording material toward the respective facet.

8. The method according to claim 1, wherein the laser beam is colored, or the laser beam is composed of laser beams of different colors that are combined to obtain an appearance of white light.

9. The method according to claim 1, wherein the photosensitive recording material is removed from the retroreflector after the hologram has been projected onto it.

10. The method according to claim 1, wherein the hologram is used as a master hologram for producing replica holograms.

11. A hologram produced according to the method of claim 1, wherein the hologram is intended for use with a light source that generates white light.

12. A method for producing a retroreflector for a vehicle, the method comprising the following steps:
producing a hologram according to the method of claim 1; and
applying the hologram to a substrate.

13. The method according to claim 12, wherein the substrate is transparent for at least part of the visible light spectrum, wherein the substrate is a component of a lighting device.

14. The method according to claim 12, wherein the substrate is opaque, wherein the substrate is a coated component.

15. A retroreflector produced according to the method of claim 12.

16. The method according to claim 5, wherein the photosensitive recording material is laminated to the a smooth upper surface of the retroreflector.

17. The method according to claim 6, wherein the photosensitive recording material is a photopolymer film.

18. The method according to claim 7, substantially the entire facet is lit by the laser beam.
